(19) United States
(12) Patent Application Publication
(10) Pub. No.: US 2026/0028479 A1
(43) Pub. Date: Jan. 29, 2026

(54) TERNARY BIODEGRADABLE POLYMER COMPOSITION CONTAINING PLA, AMORPHOUS PHA, AND PBAT AND METHOD OF PREPARING THE SAME

(71) Applicant: Kyungpook National University Industry-Academic Cooperation Foundation, Daegu (KR)

(72) Inventor: Dong Yun LEE, Suwon-si (KR)

(21) Appl. No.: 19/274,049

(22) Filed: Jul. 18, 2025

(30) Foreign Application Priority Data
Jul. 25, 2024 (KR) 10-2024-0098506

(51) Int. Cl. C08L 67/04; C08J 3/20

(52) U.S. Cl. CPC C08L 67/04; C08J 3/203; C08J 2367/04; C08J 2467/04; C08J 2467/06; C08L 2201/06; C08L 2205/03; C08L 2205/08

(57) ABSTRACT

Provided is a ternary biodegradable polymer composition including biodegradable PLA, amorphous PHA, and PBAT, and a method of preparing the same, and more specifically a composition in which amorphous PHA acts as a compatibilizer for PLA and PBAT, thereby improving the tensile strength, impact strength, and transparency of the ternary biodegradable polymer composition. The ternary biodegradable polymer composition uses a biomass-based biodegradable polymer such as PLA or aPHA and a petroleum-based biodegradable resin such as PBAT to increase the content of the biomass-based biodegradable polymer while minimizing the content of the petroleum-based biodegradable resin, thereby providing a more environmentally friendly biodegradable plastic composition.

### CROSS-REFERENCE TO RELATED APPLICATION(S)

This application claims priority to and the benefit of Korean Patent Application No. 10-2024-0098506, filed on Jul. 25, 2024, the disclosure of which is incorporated herein by reference in its entirety.

### STATEMENT REGARDING PRIOR DISCLOSURES BY THE INVENTOR OR A JOINT INVENTOR

A non-patent literature entitled, “Enhancing Mechanical Properties of Biodegradables Plastics: A Study on PLA/PHA/PBAT Ternary Blends”, which was published on Oct. 12, 2023, is not a prior art under 35 USC 102 as being a disclosure made directly or indirectly by the inventor or a joint inventor 1 year or less before the effective filing date of the instant application. A copy of the non-patent literature prior disclosure is being submitted with the instant application in an Information Disclosure Statement pursuant to 37 CFR 1.97 and 1.98.

### BACKGROUND

### 1. Field of the Invention

The present invention relates to a ternary biodegradable polymer composition comprising biodegradable poly(lactic acid) (PLA), amorphous PHA (poly(hydroxyalkanoates), and PBAT (poly(butylene adipate-co-terephthalate)), and a method of preparing the same, and more specifically a composition in which amorphous PHA acts as a compatibilizer for PLA and PBAT, thereby improving the tensile strength, impact strength, and transparency of the ternary biodegradable polymer composition.

### 2. Discussion of Related Art

Traditional plastics derived from petroleum are widely used in various fields due to their price competitiveness and functional properties. However, these plastics are difficult to decompose and pose a burden to the environment. In particular, mass production and consumption of disposable products generates approximately 4.8 to 12.7 million tons of plastic waste every year.

To solve this problem, environmental policies on plastic use are being strengthened worldwide, and interest in biodegradable plastics is increasing.

Currently, the market for biodegradable polymers consists of various types such as poly(lactic acid) (PLA), poly(hydroxyalkanoate) (PHA), and poly(butylene adipate-co-terephthalate) (PBAT), and in particular, biodegradable polymers derived from biomass are attracting attention. This is because biomass-based biodegradable polymers can reduce carbon dioxide during the biomass growth process.

Large-scale PLA is produced from biomass raw materials such as corn and starch, and is most widely used due to its environmental friendliness and food contact safety. However, PLA has the disadvantages of slow crystallization rate and high brittleness.

Another biomass-based biodegradable polymer, PHA, is obtained by synthesizing and polymerizing hydroxybutyrate within cells through microbial fermentation, and has the advantage of providing excellent biodegradability. Depending on the monomer ratio, it can be classified as crystalline, semi-crystalline, or amorphous, and recently, amorphous PHA (aPHA) with rubber-like transparency, impact resistance, and excellent flexibility but low tensile strength is attracting attention.

On the other hand, PBAT, a copolymer derived from terephthalic acid, adipic acid, and butanediol, is known as a petroleum-based biodegradable polymer with high elongation and tensile strength.

Although the biodegradable polymers described above are sometimes used alone, it is not easy to satisfy the properties required for practical applications using only a single biodegradable polymer. This is because it is difficult to secure satisfactory compatibility and miscibility between polymers with large differences in molecular weight and solubility parameters. Therefore, research and development are being conducted on additives such as compatibilizers and biodegradable polymer blends with good compatibility.

For example, in order to improve the brittleness of PLA, it is often mixed with copolymers, plasticizers, rubber, or rubber-like polymers, and complete miscibility can be achieved by adding plasticizers, or partial miscibility of PLA with other copolymers can be achieved to improve the impact strength.

In the case of PLA/PBAT blends, it has been reported that while the ductility of PLA is improved, instability between the interface of the two polymers causes pore formation and deterioration of physical properties. There was also a report that adding a plasticizer to the PLA/PBAT blend improved the mechanical properties by enhancing the adhesion at the interface between the two polymers. Meanwhile, although the addition of rubber-like amorphous polyhydroxyalkanoate (aPHA) to PLA has been reported to significantly improve the toughness of PLA, further improvement is still needed because the mechanical properties of PHA are much lower than those of PLA and PBAT.

To solve this problem, research on functional additives such as reactive compatibilizers is actively being conducted, but development of multi-component blends using biodegradable polymers is still insufficient.

The ternary blend system is a system that increases compatibility by introducing an appropriate third component between two incompatible polymers. It is expected that adding a third polymer that acts as a compatibilizer within a binary polymer blend with poor compatibility will improve interface stability by positioning the added polymer between the two polymers. This method has the advantage of not losing the excellent biodegradability of biodegradable polymers, but the development of a ternary polymer blend system with biodegradability has not yet been fully progressed.

### SUMMARY OF THE INVENTION

The present invention is intended to solve the problems described above, and to provide a ternary biodegradable polymer blend composition with biodegradability while overcoming the physical vulnerability of existing binary biodegradable polymer blends. In particular, the ternary biodegradable polymer blend composition according to the present invention uses biomass-based biodegradable polymers such as PLA and aPHA and a petroleum-based biodegradable polymer such as PBAT, thereby maximizing the content of the biomass-based biodegradable polymer in the ternary biodegradable polymer blend composition, and thereby producing a composition having improved tensile strength, impact strength, and transparency.

The present invention provides a ternary biodegradable polymer composition comprising PLA, amorphous PHA, and PBAT, wherein the ternary biodegradable polymer composition may preferably comprise 70 wt % of PLA, 5 to 25 wt % of amorphous PHA, and 25 to 5 wt % of PBAT, and more preferably comprise 70 wt % of PLA, 15 wt % of amorphous PHA, and 15 wt % of PBAT.

A biodegradable ternary polymer composition according to the present invention may increase the content of a biomass-based biodegradable polymer such as PLA and amorphous PHA while minimizing the content of the petroleum-based biodegradable resin such as PBAT, thereby providing a more environmentally friendly biodegradable plastic composition.

In addition, the amorphous PHA may act as a compatibilizer for PLA and PBAT to reduce the pore between the interfaces of PLA and PBAT, thereby improving transparency as well as mechanical properties such as tensile strength, elongation, and impact strength.

The present invention provides a method of preparing a ternary biodegradable polymer composition comprising PLA, amorphous PHA, and PBAT, the method comprising the steps: drying PLA, amorphous PHA, and PBAT; and melt mixing a mixture of PLA, amorphous PHA, and PBAT, wherein the step of melt mixing the mixture of PLA, amorphous PHA, and PBAT may be performed at 190° C. for 10 minutes, and the ternary biodegradable polymer composition may comprise 70 wt % of PLA, 5 to 25 wt % of amorphous PHA, and 25 to 5 wt % of PBAT.

### Advantageous Effects

The ternary biodegradable polymer composition according to the present invention introduces a ternary system comprising PLA, amorphous PHA, and PBAT to increase the content of biomass-based biodegradable polymers while minimizing the content of petroleum-based biodegradable polymers, thereby providing a more environmentally friendly biodegradable plastic composition, as well as providing a composition with improved tensile strength, impact strength and transparency, as the amorphous PHA acts as a compatibilizer for PLA and PBAT.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows the results of measuring the tensile strength and elongation at break for each composition ratio in a binary blend of PLA and PBAT;

FIG. 2 shows SEM images of the fracture surfaces of specimens of examples and comparative examples according to the present invention. (a) Comparative Example 1, (b) Example 1, (c) Example 2, (d) Example 3, (e) Example 4, (f) Example 5, and (g) Comparative Example 2;

FIG. 3 shows the surface energy and the spreading coefficient calculated according to Harkins' equation;

FIG. 4 shows (a) a schematic diagram and (b) an actual SEM image of the fracture surface of the specimen according to the aPHA content added to the PLA/PBAT blend;

FIG. 5 shows (a) the storage modulus and (b) the complex viscosity of specimens of examples and comparative examples according to the present invention during a rheometer frequency sweep;

FIG. 6 shows melt flow index values for compositions of examples and comparative examples according to the present invention;

FIG. 7 shows photographs for comparing the transparency of films of examples and comparative examples according to the present invention. (a) Comparative Example 1, (b) Example 1, (c) Example 2, (d) Example 3, (e) Example 4, (f) Example 5, and (g) Comparative Example 2;

FIG. 8 shows (a) the transmittance spectra of the films of examples and comparative examples in the visible light range (380 to 800 nm) and (b) the transmittance spectra of the films of example and comparative examples at a wavelength of 600 nm.

### DETAILED DESCRIPTION OF EXEMPLARY EMBODIMENTS

The terminology used herein is for the purpose of describing the embodiments, and is not intended to limit the present invention. In this specification, a singular expression includes a plural expression unless the context clearly indicates otherwise. The word “comprises” as used in the specification does not exclude the presence or addition of one or more other components other than the mentioned components.

Unless otherwise defined, all terms (including technical and scientific terms) used in the present specification may be used in a meaning commonly understood by those of ordinary skill in the art to which the present invention belongs. In addition, terms defined in commonly used dictionaries are not interpreted ideally or excessively unless explicitly specifically defined.

The present invention provides a ternary biodegradable polymer composition comprising PLA, amorphous PHA, and PBAT.

The ternary biodegradable polymer composition according to the present invention may include 70 wt % of PLA, 5 to 25 wt % of amorphous PHA, and 25 to 5 wt % of PBAT, and preferably, the ternary biodegradable polymer composition may include 70 wt % of PLA, 15 wt % of amorphous PHA, and 15 wt % of PBAT.

The ternary biodegradable polymer composition according to the present invention may further include one or more additives selected from an antioxidant, a processing aid, an inorganic filler, an organic filler, and a biodegradable filler.

The ternary polymer composition according to the present invention may increase the content of a biomass-based biodegradable polymer such as PLA and amorphous PHA while minimizing the content of the petroleum-based biodegradable resin such as PBAT, thereby providing a more environmentally friendly biodegradable plastic composition.

In addition, the amorphous PHA may act as a compatibilizer for PLA and PBAT to reduce the pore between the interfaces of PLA and PBAT, thereby improving transparency as well as mechanical properties such as tensile strength, elongation, and impact strength.

The present invention provides a method of preparing a ternary biodegradable polymer composition comprising PLA, amorphous PHA, and PBAT, the method comprising the steps: drying PLA, amorphous PHA, and PBAT; and melt mixing a mixture of PLA, amorphous PHA, and PBAT, wherein the step of melt mixing the mixture of PLA, amorphous PHA, and PBAT may be performed at 190° C. for 10 minutes, and the ternary biodegradable polymer composition may comprise 70 wt % of PLA, 5 to 25 wt % of amorphous PHA, and 25 to 5 wt % of PBAT.

Hereinafter, the ternary biodegradable polymer composition comprising PLA, aPHA, and PBAT, the method of preparing the same, and the physical characteristics and biodegradability of the ternary biodegradable polymer composition comprising PLA, aPHA, and PBAT will be described in detail through examples of the present invention so that a person having ordinary skill in the art to which the present invention pertains can easily carry out the invention. However, the present invention may be embodied in many different forms and is not limited to the embodiments set forth herein.

### 1. Physical Properties of Binary Blend Biodegradable Polymer Composition of PLA and PBAT

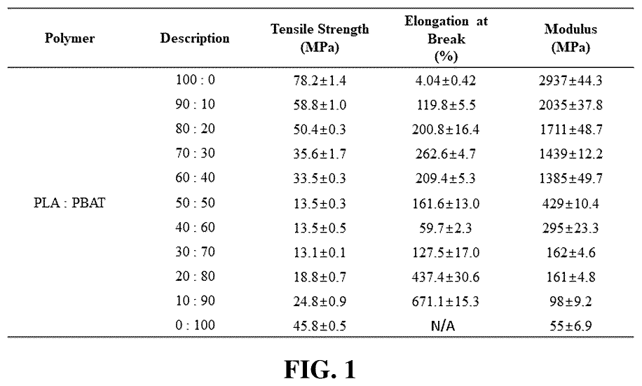

FIG. 1 shows the results of measuring the tensile strength and elongation according to the composition ratio of PLA and PBAT blends conducted as a preliminary experiment.

As shown in FIG. 1, as PBAT is added to PLA, the tensile strength decreases and the elongation gradually increases. When PBAT is added in an amount of 50 to 60 wt % or more, the tensile strength and elongation approach those of PBAT.

Therefore, in the present invention, a composition mixed with 70 wt % of PLA and 30 wt % of PBAT, which belongs to the region with the best elongation, was selected, and the physical properties and fracture characteristics of the ternary biodegradable polymer composition were investigated while changing the amount of amorphous PHA instead of the PBAT.

### 2. Preparation of Ternary Biodegradable Polymer Composition Comprising PLA, Amorphous PHA, and PBAT

PLA was Ingeo™ Biopolymer 2003D from Nature Works Co., Ltd., and aPHA (amorphous PHA) was a product from CJ CheilJedang Corp., characterized by its flexible, rubber-like physical properties. PBAT used was A400 from Kingfa Sci.&Tech. Co., Ltd.

PLA, PBAT, and aPHA were dried in a vacuum oven at 50° C. for 24 h, and PLA, PBAT, and aPHA were prepared in the ratios showed in Table 1 and mixed using a Plasti-Corder Lab-Station equipped with a W 50 EHT mixer (Brabender, Duisburg, Germany). Each sample was mixed at 190° C. with a rotation speed of 50 rpm for a total of 10 min.

While the PLA content was kept constant at 70 wt %, aPHA/PBAT was adjusted within the range of 0/30 to 30/0 (wt %/wt %).

The ternary blend compositions mixed in the ratios shown in Table 1 were prepared in the form of specimens using a hot press (Model 3851, Fred S. Carver Inc., Menomonee Falls, WI, USA). After the mixture was preheated at 190° C. for 2 min using the hot press, specimens were prepared under a compressive load of 10 MPa in a mold measuring 80×65 mm, and each specimen weighed about 7 g.

TABLE 1

| | Comparative | Comparative | | |
|---|---|---|---|---|
| Components | Example 1 | Example 2 | Example 1 | Example 2 |
| PLA | 70 | 70 | 70 | 70 |
| PBAT | 30 | — | 25 | 20 |
| aPHA | — | 30 | 5 | 10 |
| <Mechanical properties> | | | | |
| Tensile strength (MPa) | 50.2 ± 4.6 | 22.1 ± 0.3 | 27.6 ± 1.4 | 25.8 ± 0.8 |
| Yield strength (MPa) | 50.3 ± 4.6 | 29.8 ± 0.5 | 39.5 ± 1.5 | 36.1 ± 4.1 |
| Elongation (%) | 278.8 ± 18.7 | 100.0 ± 1.8 | 22.0 ± 1.2 | 35.9 ± 4.5 |
| Elastic modulus | 1567.1 ± 5.4 | 1564.1 ± 26.7 | 1826.3 ± 31.4 | 1613.3 ± 73.4 |
| Izod impact strength | 5.7 ± 0.3 | 9.3 ± 0.5 | 4.4 ± 0.3 | 5.9 ± 0.4 |

| Components | Example 3 | Example 4 | Example 5 |
|---|---|---|---|
| PLA | 70 | 70 | 70 |
| PBAT | 15 | 10 | 5 |
| aPHA | 15 | 20 | 25 |
| Tensile strength (MPa) | 28.5 ± 2.6 | 26.0 ± 0.8 | 28.7 ± 2.7 |
| Yield strength (MPa) | 38.7 ± 3.6 | 34.2 ± 1.4 | 37.7 ± 0.3 |
| Elongation (%) | 33.7 ± 3.2 | 37.4 ± 2.78 | 32.2 ± 0.3 |
| Elastic modulus | 1802.5 ± 6.2 | 1435.4 ± 4.2 | 1772.2 ± 0.3 |
| Izod impact strength | 7.7 ± 0.5 | 8.7 ± 0.4 | 10.0 ± 0.6 |

### 3. Characteristics Evaluation of Ternary Biodegradable Polymer Composition Comprising PLA, PHA, and PBAT

### <Observation of Fracture Surface and Theoretical Consideration of Fracture Surface Shape>

To observe the fracture surface of the ternary blend, field emission scanning electron microscopy (FE-SEM, S-4800, Hitachi High-Technology) was used. Images were taken at 5.0 kV voltage, each specimen was fractured using liquid nitrogen, and then the fracture surface was coated with platinum.

A contact angle measuring meter (Phoenix-10, SEO) was used to measure the surface energy of PLA, aPHA, and PBAT films, and distilled water and diiodomethane, which represent polar and nonpolar properties, were used.

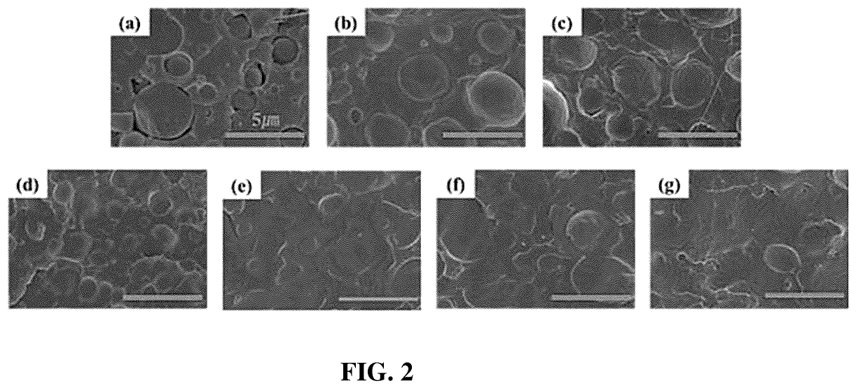

FIG. 2 shows the fracture surfaces for each specimen. (a) is the case of Comparative Example 1, where 70 wt % of PLA formed a matrix phase and 30 wt % of PBAT formed a domain phase, and pores were observed between the interface of the two components. However, as the content of PBAT decreased and the content of aPHA increased, that is, from Example 1 (FIG. 2B) to Example 5 (FIG. 2F), the pores between PLA and PBAT decreased, and there was a tendency for PBAT to be incorporated into the interior of aPHA.

These results are consistent with previously reported results observed when compatibilizers were added to PLA/PBAT blends.

Therefore, it is believed that aPHA acts as a compatibilizer in the ternary blend comprising PLA, PBAT, and aPHA to stabilize the interfacial morphology of the ternary blend.

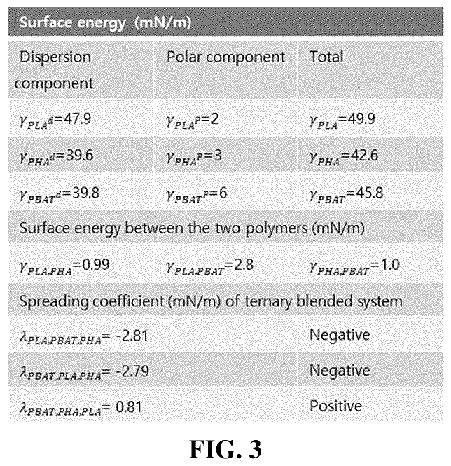

FIG. 3 shows the surface energy and the spreading coefficient calculated according to Harkins' equation.

The diffusion coefficient has two negative values and one positive value, which means complete wetting, where one component completely covers the surface of the other component, filling all the pores and there is full contact between the different components. That is, aPHA fills the interface between PLA and PBAT, preventing the appearance of boundaries or pores.

In addition, the position of each component is related to the surface energy, and the surface energy between PLA/aPHA and aPHA/PBAT is about 1.0 mN/m lower than that between PLA/PBAT (2.7 mN/m). Therefore, in the PLA/aPHA/PBAT ternary blend system, the high interfacial tension between PLA/PBAT means that the two components do not form an interface, and aPHA is present between the interfaces of PLA and PBAT, which means that aPHA acts as a compatibilizer for PLA and PBAT.

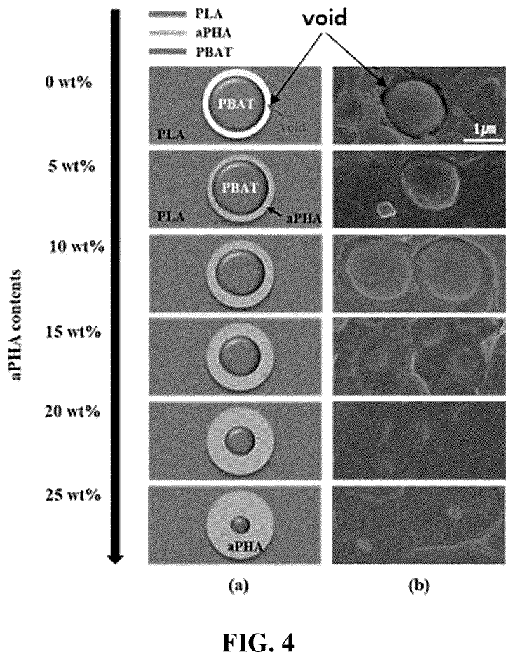

Therefore, as shown in FIG. 4A, when aPHA is added, aPHA is located in the pore between PLA and PBAT, and aPHA fills the pore by forming an interface with PLA, and as the aPHA content increases further, the area of aPHA expands and PBAT is located inside aPHA. This theoretical interpretation is in good agreement with the observation results (FIG. 4B) of the fracture surface of the specimen.

### <Mechanical Properties>

The elastic modulus, tensile strength, yield strength, and elongation at break of the ternary blend were measured using a universal testing machine (UTM, ST-1001, Salt Inc., Korea). Each value was calculated as the average of seven measurements excluding the maximum and minimum values according to ASTM D882. In addition, to determine whether the toughness of PLA was improved, the impact strength was evaluated. The Notched Izod impact strength was measured in accordance with ASTM D256 using an impact tester (CEAST 9050, INSTRON), and the result is expressed as the average of five measurements, excluding the highest and lowest values. Specific values of the mechanical properties are shown in Table 1.

Due to the introduction of aPHA, the tensile strength of the ternary blend is lower than that of Comparative Example 1 (PLA70/PBAT30), which is thought to be because aPHA has flexible rubber-like properties. In the case of impact strength, when the aPHA content increases, the value of PLA70/aPHA25/PBAT5 (Example 5) is 10.0 KJ/m², which is an improvement of about 75% over 5.7 kJ/m² of PLA70/PBAT30 (Comparative Example 1). This is because the addition of aPHA effectively disperses external impact energy and enhances impact resistance through shape stabilization. In addition, the tensile strength of PLA70/PHA30 (Comparative Example 2) is 22.1 MPa, and all ternary blends exhibit a tensile strength exceeding 25 MPa. In particular, Example 3 (PLA70/PHA15/PBAT15) showed the most balanced characteristics with a tensile strength of 28.5 MPa, an elastic modulus of 1802.5 MPa, and an impact strength of 7.7 J/m².

### <Thermal Properties>

The thermal properties of the ternary blend were analyzed using a differential scanning calorimeter (DSC25, TA instrument). Each specimen was heated to 190° C., cooled to −80° C. (first run), and then heated again from −80° C. to 190° C. (second run), with the heating and cooling rates set to 10° C./min. The sample weighed 7±0.5 mg and was tested in a nitrogen atmosphere. The degree of crystallinity (Xc) was calculated by the following equation:

$$Xc ( \% ) = ( Δ Hm - Δ Hcc ) / ( Δ Hm {,}_{100} ) \times 100$$

Here, ΔHm is the melting enthalpy measured in the second run, ΔHcc is the cooling crystallization enthalpy, and ΔHm,₁₀₀ is the melting enthalpy for 100% crystallization. The above ΔHm,₁₀₀ is a value provided by the document, which is 93.7 J/g for PLA, 146 J/g for aPHA, and 114.7 J/g for PBAT.

In addition, a dynamic mechanical analyzer (DMA, N535, Perkin-Elmer) was used to investigate the compatibility of the ternary blend using glass transition temperatures. Analyses using DMA were performed over a temperature range of −70° C. to 100° C. at a heating rate of 5° C./min and a fixed frequency of 1 Hz.

The measured thermal characteristic values are shown in Table 2.

TABLE 2

| | Tg of | Tg of | Tg of | | | | |
|---|---|---|---|---|---|---|---|
| | PLA | PBAT | aPHA | Tm | ΔHc | ΔHf | Xc |
| Number | (° C.) | (° C.) | (° C.) | (° C.) | (J/g) | (J/g) | (%) |
| Comparative | 58.63 | −33.71 | — | 151.54 | 5.17 | 6.38 | 1.21 |
| Example 1 | | | | | | | |
| Comparative | 57.23 | — | −18.93 | 150.69 | 8.61 | 9.12 | 0.47 |
| Example 2 | | | | | | | |
| Example 1 | 58.18 | −34.03 | −16.93 | 147.77 | 14.17 | 17.21 | 2.89 |
| Example 2 | 57.36 | −34.23 | −16.95 | 147.84 | 12.68 | 15.62 | 2.95 |
| Example 3 | 57.03 | −33.08 | −16.59 | 148.87 | 12.24 | 13.74 | 2.25 |
| Example 4 | 57.40 | −33.25 | −16.79 | 149.48 | 10.69 | 13.05 | 1.45 |
| Example 5 | 57.39 | −33.64 | −16.53 | 149.78 | 10.07 | 11.21 | 1.01 |

For polymer blends, it is judged that there is compatibility between the blended polymers when the Tg peaks become closer or merge into one Tg peak. In the case of Example 3 (PLA70/aPHA15/PBAT15), the Tg of PBAT is −33.08° C., that of aPHA is −16.59° C., and that of PLA is 57.03° C., and the Tg peaks of the three components have the closest values. This well explains why the composition of Example 3 exhibits the best mechanical properties as described above.

In addition, the melting enthalpy (ΔHf) of the ternary blend shows a larger value than that of Comparative Example 1 (PLA70/PBAT30) and Comparative Example 2 (PLA70/aPHA30).

It is known that when there is compatibility in the amorphous region, melting enthalpy is generated due to the dilution effect between polymers, and the greater the compatibility, the higher the melting enthalpy value.

Therefore, it is believed that when a small amount of aPHA is added, the degree of freedom of the chain increases, lowering the energy barrier required to form a crystal structure, so the melting enthalpy and crystallinity of Examples 1 to 5 increase compared to Comparative Example 1 (PLA70/PBAT30).

However, starting from Example 5 (PLA70/aPHA25/PBAT5), the crystallinity decreases again, which is believed to be due to the intermolecular interaction between PLA and aPHA, which hinders the formation of crystals.

In addition, when tan δ was measured as a function of temperature using DMA, the tan δ peaks of aPHA and PBAT appeared at approximately −16° C. and −30° C., respectively, while that of PLA was observed around 60° C. These values correspond to the respective glass transition temperatures and are consistent with the conclusions derived from the above DSC analysis.

In the case of the ternary blend system comprising aPHA, the peak Tg of PLA is 64.3° C. for Example 1 (PLA70/aPHA5/PBAT25), and decreases to 62.6° C. for Example 5 (PLA70/aPHA25/PBAT5).

That is, as the content of aPHA in the ternary blend increases, the tan δ peak difference between PLA, aPHA, and PBAT decreases, which suggests that the flexible aPHA acts as a compatibilizer between the PLA and PBAT blend.

### <Rheological Properties>

To confirm the morphological changes of the ternary blend according to the Harkins theory, the interfacial effects between the components were investigated in the molten state using a rheometer. The melting state of the specimen was analyzed using a rheometer (HR20, TA Instruments) at 175° C. with a 25 mm parallel plate geometry and a 1 mm gap. First, to determine the linear viscoelastic region, strain sweeps were performed at a strain of 0.01 to 100% at a frequency of 10 Hz. Then, a frequency sweep test was performed from 100 to 0.1 Hz at a strain of 2.5%. In addition, to verify that the sample was not decomposed during the frequency sweep test, a time sweep test was conducted for 20 minutes.

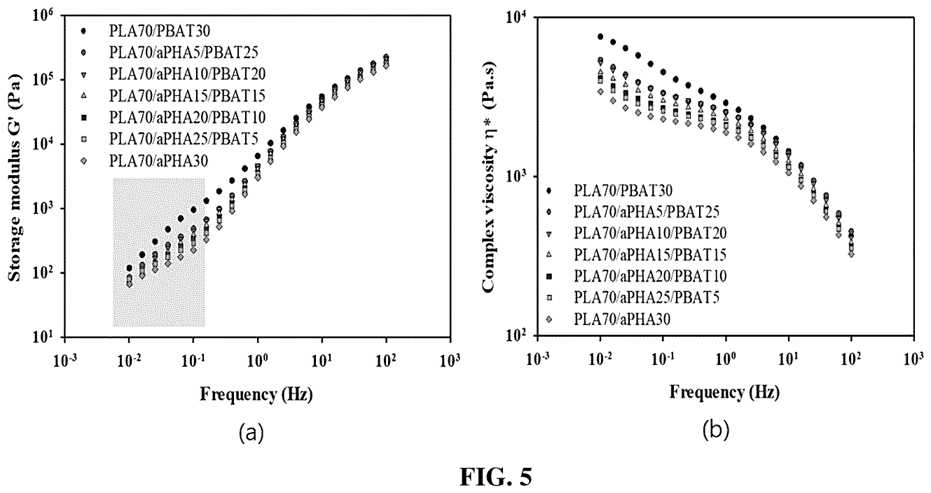

FIG. 5 shows the storage modulus and complex viscosity during frequency sweep. When polymer blends are present in the form of a matrix and domains, the deformation and recovery process due to shear stress is observed as an elastic process. Moreover, these deformation and recovery processes occur prominently in the low-frequency region. This is a phenomenon that does not affect the storage modulus because the effect of the interface is so small that it can be ignored in the high-frequency region, but it is considered and appears in the low-frequency region.

Looking at the low-frequency region in FIG. 5A, the storage moduli of all ternary blends are lower than that of Comparative Example 1 (PLA70/PBAT30). This result may be attributed to the interface formed between PLA and PBAT, as in the SEM results described above, and the flexible property of aPHA facilitate the deformation and recovery process of the interface between each component.

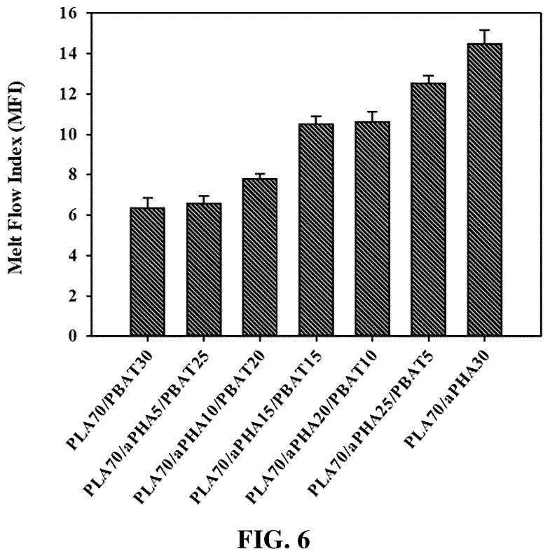

FIG. 5B shows the complex viscosity from the frequency sweep, which corresponds to the melt viscosity. All blends exhibit non-Newtonian behavior, particularly shear thinning. In addition, the complex viscosity decreases as the content of aPHA in the ternary blend increases, which is consistent with the low viscosity of aPHA and the measured melt flow index values shown in FIG. 6.

In addition, a time sweep test was performed for 20 minutes to confirm whether the above results were a phenomenon resulting from the decomposition of biodegradable polymers exposed to high temperatures during the frequency sweep, but it was confirmed that there was little effect due to decomposition since the storage modulus of all samples changed by less than 1% on a log scale.

### <Optical Properties>

To verify the opacity caused by the pore between the interfaces of the ternary blend, the transmittance was evaluated.

The transmittance for the wavelength band of 300-800 nm was measured using a UV-visible spectrum analyzer (JV-770, JASCO). A thickness of the film used to measure the transmittance was approximately 50 μm, and air was used as a reference material.

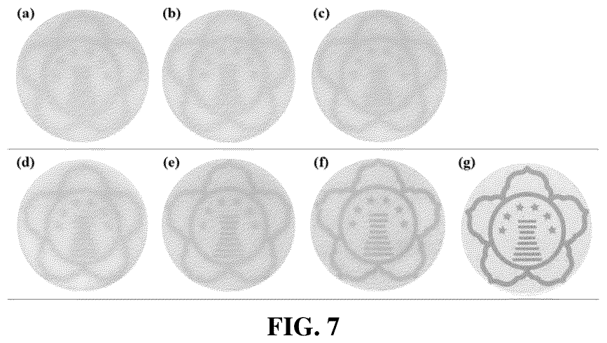

FIG. 7 shows photographs comparing the transparency of films according to comparative examples and examples.

As seen in FIGS. 7B to 7F, it can be confirmed that transparency improves as the aPHA content increases in the ternary blend system of PLA, aPHA, and PBAT.

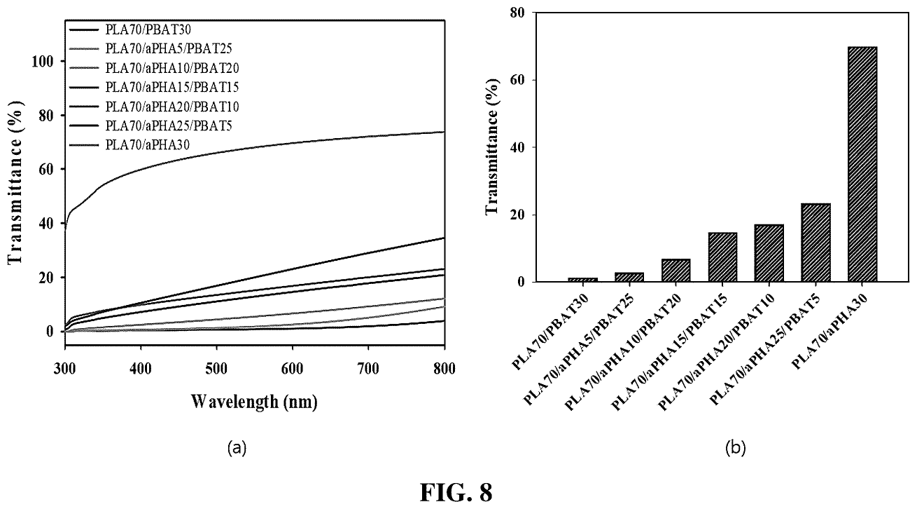

FIGS. 8A and 8B show the transmittance spectrum of each film in the visible light range (380 to 800 nm) and the transmittance at a wavelength of 600 nm, respectively.

As can be seen from the results observed with the naked eye in FIG. 7, transparency gradually increases as the content of aPHA increases, and as seen in FIG. 7B, Comparative Example 1 (PLA70/PBAT30) exhibited the lowest (1.1%) transmittance. On the other hand, Comparative Example 2 (PLA70/aPHA30) showed the highest transmittance of 69.7%. Example 5 (PLA70/aPHA25/PBAT5) showed a transmittance of about 23%, which was about 23 times higher than that of Comparative Example 1 (PLA70/PBAT30).

In the case of Comparative Example 1 (PLA70/PBAT30), the lowest transmittance is judged to be due to light scattering caused by pores inside the film, as seen in the SEM observation results. In addition, it is judged that the increase in transparency with the addition of aPHA in the ternary blend system is because the pores between PLA and PBAT disappear due to the addition of aPHA.

These results are consistent with the observation that the addition of a compatibilizer to a non-compatible polymer blend system increases the transparency of the blend system. Therefore, it can be confirmed that aPHA plays the role of a compatibilizer in the ternary blend system of PLA, aPHA, and PBAT according to the present invention.

What is claimed is:

1. A ternary biodegradable polymer composition comprising PLA, amorphous PHA, and PBAT.

2. The ternary biodegradable polymer composition of claim 1, wherein the ternary biodegradable polymer composition comprises 70 wt % of PLA, 5 to 25 wt % of amorphous PHA, and 25 to 5 wt % of PBAT.

3. The ternary biodegradable polymer composition of claim 2, wherein the ternary biodegradable polymer composition comprises 70 wt % of PLA, 15 wt % of amorphous PHA, and 15 wt % of PBAT.

4. A method of preparing a ternary biodegradable polymer composition comprising PLA, amorphous PHA, and PBAT, the method comprising:
drying PLA, amorphous PHA, and PBAT; and
melt mixing a mixture of the PLA, amorphous PHA, and PBAT.

5. The method of claim 4, wherein the melt mixing the PLA, amorphous PHA, and PBAT mixture is performed at 190° C. for 10 minutes.

6. The method of claim 4, wherein the ternary biodegradable polymer composition comprises 70 wt % of PLA, 5 to 25 wt % of amorphous PHA, and 25 to 5 wt % of PBAT.
